(19) United States
(12) Patent Application Publication
(10) Pub. No.: US 2009/0228826 A1
(43) Pub. Date: Sep. 10, 2009

(54) GROUP FILTERING OF ITEMS IN A VIEW

(75) Inventors: Michael Gilmore, Bothell, WA (US); Paul A. Gusmorino, Seattle, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 12/041,996

(22) Filed: Mar. 4, 2008

(51) Int. Cl. G06F 3/048

(52) U.S. Cl. 715/781

(57) ABSTRACT

Embodiments of the invention provide a method, system, and media for presenting on a computing device a view that contains representations of items such as files. The view can include multiple groups of representations, which each correspond to items (such as files, users, network elements, etc.). The representations are grouped together based on at least one property of the items. A group delimiter separates each of the multiple groups. At least one of two manipulation options is provided by way of the respective group delimiters. A first manipulation option enables removing a desired group from the view. A second manipulation option enables showing only a selected group in the view.

### SUMMARY

The invention is defined by the claims below. This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed are ways of grouping representations of items in a view of a user interface. The representations of items (e.g., icons and the like) can be grouped, filtered on, and then successively filtered on without regard to the previous items that had been removed after applying a filter. For example, a set group of representations can be separated by a group delimiter that can be directly interacted with by a user to effect a filtering option. At least one of two manipulation options are made accessible by way of the group delimiter. A first manipulation option enables removing a desired group from the view, and a second manipulation option enables showing only items from a selected group in the view.

### BRIEF DESCRIPTION OF THE SEVERAL VIEWS OF THE DRAWINGS

Embodiments of the invention are described in detail below with reference to the drawing figures, which form a part of this disclosure, and are incorporated by reference herein, and wherein:

FIG. 1 depicts an illustrative operating environment suitable for practicing an embodiment of the present invention;

FIG. 2 depicts an illustrative block diagram of an exemplary computing device of FIG. 1;

FIG. 3 depicts an illustrative view that includes delimiters and shows properties and values of those properties according to an embodiment of the present invention;

FIG. 4.1 depicts another illustrative view according to an embodiment of the present invention;

FIG. 4.2 depicts another view and includes other examples of manipulation options according to an embodiment of the present invention;

FIG. 4.3 provides greater detail regarding manipulation options according to embodiments of the present invention;

FIG. 4.4 depicts a context menu for interacting with elements of a view according to an embodiment of the invention;

FIG. 5 depicts a filtered set with respect to FIG. 4.1 such that only a desired subset of elements is visible according to an embodiment of the present invention;

FIG. 6 depicts a grouping option that is presentable that can cause still another filtering of a filtered subset;

FIG. 7 depicts that a filtered subset can be filtered again without presenting elements that were not part of the original filtered subset according to an embodiment of the present invention;

FIGS. 8.1-8.4 depict prior art wherein items are merely collapsed;

FIG. 9 depicts a first method for managing a presentation of a set of representations of items in a view according to an embodiment of the present invention; and

FIG. 10 depicts another illustrative method for managing a presentation of a set of representations of items in a view according to an embodiment of the present invention.

### DETAILED DESCRIPTION

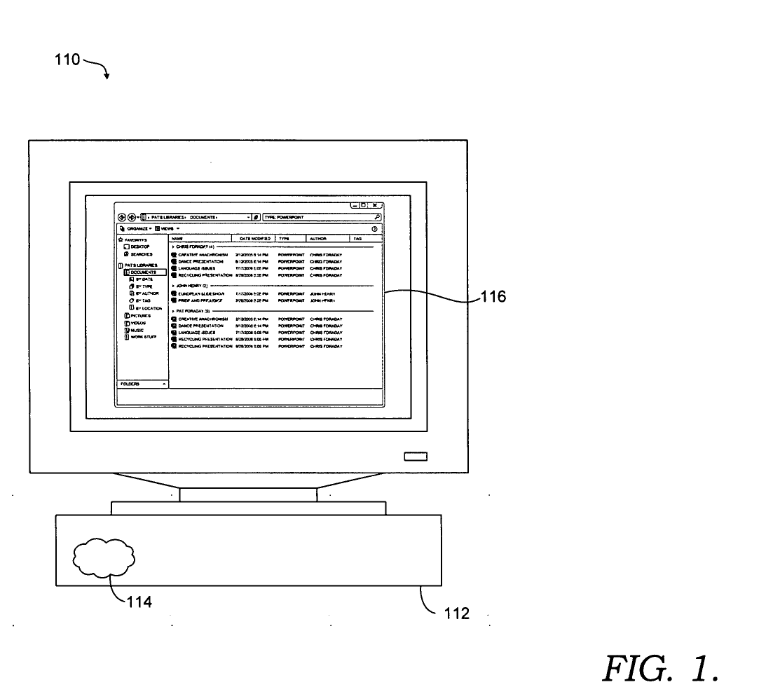

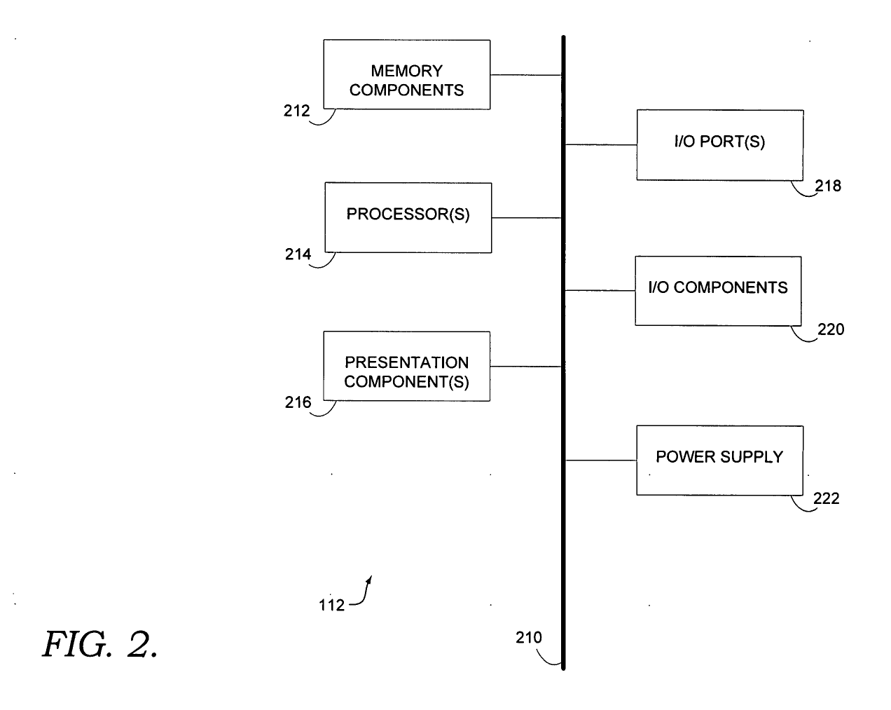

Turning now to FIG. 1, an illustrative operating environment suitable for practicing an embodiment of the invention is provided and referenced generally by the numeral 110. Operating environment 110 includes a computing device 112 (which might variously be referred to as a computer), which is schematically described in greater detail in FIG. 2.

Briefly turning to FIG. 2, a diagrammatic block diagram of computer 112 is provided. Computer 112 may take on a variety of forms, including, for example, a computing device such as a client computer, a server computer, the variations thereof such as laptop computers and palm-top computers, and in some embodiments devices such as PDAs and smart phones. As shown in FIG. 2, a bus 210 couples one or more memory components 212 to one or more processors 214, various presentation components 216, input/output ports 218, input/output components 220, and at least one power supply 222. Other devices including lower level aspects of the shown devices are not shown so as to not obscure the invention.

Memory components 212 include things such as a hard drive, volatile memory (such as RAM), buffers, and the like. The one or more processors 214 control overall data communications throughout computer 212. Illustrative presentation components 216 include a video card as well as a monitor or other presentation device. Input/output ports 218 provide connectivity to peripheral components such as printers, digital cameras, and the like. Actual input/output components may be things like printers and the like. A power supply 222 provides power to run computing device 112. Not all of the components shown in FIG. 2 need to be present in order to make up a computing device but are shown for illustrative purposes in connection with describing an embodiment of the invention.

Although the various blocks of FIG. 2 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art and reiterate that the diagram of FIG. 2 is merely illustrative of an exemplary computing device that can be used in connection with one or more embodiments of the present invention.

Computing device 112 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave, or any other medium that can be used to encode desired information and be accessed by computing device 112.

Returning now to FIG. 1, operating environment 110 indicates that computer 112 includes a set of computer-executable instructions 114 (variously referred to as application 114) that are embodied on one or more computer-readable media, illustrative examples of which include memory components 212, which could be local or remote. An application 114 results in computer 112 being programmed to perform various aspects of various embodiments of the invention. Application 114 may actually be composed of a variety of constituent modules or other programmatic code portions but is referenced generally herein by the numeral 114 for ease of reference. For example, an embodiment of the invention may take the form of embodied programmatic code that is run in what is known as layers that, in one embodiment, cooperate to present a view 116 on computing device 112.

We will be using the term “view” often throughout this disclosure. An accurate definition of what we mean by the term “view” can be gleaned by reading the totality of this disclosure as well as a copending application having U.S. Ser. No. 11/969,654, which is incorporated by reference herein to provide a more comprehensive disclosure regarding what a view is as well as to provide more information on aspects of how a view is made and used, including aspects about the aforementioned layers, which are not shown in the instant figures for the sake of conciseness in this disclosure, but which the aforementioned application describes in detail.

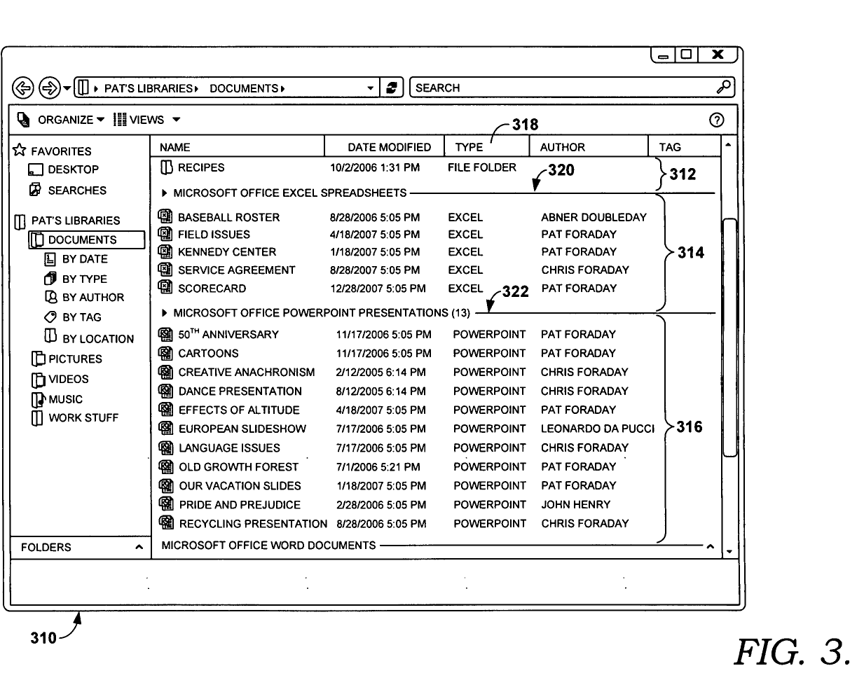

Summarily, a view is a portion of a user interface (UI) that presents representations of items in a computing environment. This is not a rigorous definition but provides a start. Illustrative items that can be represented include files, network components (network storage devices, routers, and the like), users, etc. Representations of these items are presented in a view, which most people will commonly refer to as a window. A view presents representations of items, often files, as a result of a user's desire to browse contents of a computing system and to present search results from a query among other themes. An illustrative view is shown in FIG. 3.

Turning to FIG. 3, a view is referenced generally by the numeral 310. This example of a view shows a set of groups of representations corresponding to items. In the particular example, three groups of representations are shown, and are respectively referenced by numerals 312, 314, and 316. By way of illustration, the groups of representations are grouped by file type, as indicated by numeral 318. The representations are grouped together based on at least one property of the items.

An item may have an array of properties. Illustrative properties include a file author, a file size, a file name, a file type, a date, an item of metadata that is associated with an audio file, an item of metadata associated with a video file, and an item of metadata associated with a picture file. Illustrative examples of metadata that might be associated with either an audio file, video file, and/or picture file include an album title, an album year, a track number, a genre, a duration, a bit rate, an indication as to whether content is protected or not, a camera model, a picture resolution, a screen-resolution size, a user-designated flag, and the like.

These properties that we have provided by way of illustration are just that, illustrations. Other properties exist as well such as an indication of an owner, attributes, date modified, date created, and more, but listing all of such properties would be cumbersome inasmuch as we mean to convey a representative but not exhaustive list.

As mentioned, the groups of representations are grouped together based on at least one property of the items. As shown in view 310, an exemplary property is file type. That is, the representations of view 310 are grouped based on file type. To be grouped based on a property does not necessarily imply that every element in a group share or have in common that property. More accurately, to be grouped together based on at least one property contemplates that some aspect of that property is shared by the elements that make up a group. Although it happens to be the case that the representations in view 310 actually do share and have in common the property of being the same file type, had they been sorted, for example by file name, then they may be grouped according to the first letter of the file name.

That is, although each file does not share the same file name, they share an aspect of a file name; namely, that they all start with the same letter. Similarly, if representations (which we will variously refer to as “elements”) were grouped based on size, all elements of the group may not necessarily be the same size, but they might share a certain threshold in size. That is, they may be less than 5 megabytes and the next set less than 50 megabytes and the next set less than 100 megabytes for example.

View 310 shows that elements of group 316 are all presentation files. Similarly, the representations that make up group 314 are all spreadsheet files. As can also be seen, column headers provide an easy way to regroup items in view 310. Five illustrative column headers are shown: “name,” “date modified,” “type,” “author,” and “tag.” Clearly, other column headers could be provided instead of those shown, but the ones that are shown are for illustrative purposes.

As can also be seen in view 310, a group delimiter is provided to separate each of the groupings. A first illustrative delimiter is referenced by numeral 320, and a second illustrative delimiter is denoted by numeral 322. A delimiter can be any user-interface mechanism that separates the groups. In an embodiment of the present invention, users are provided the ability to directly interact with the delimiters to effect, or cause, different elements to be presented.

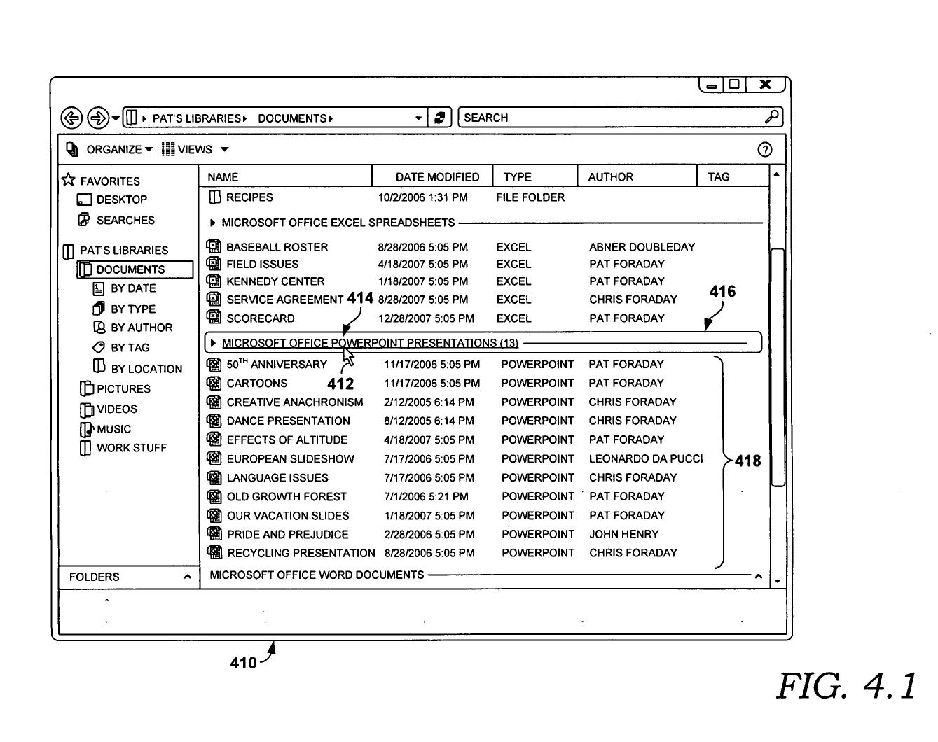

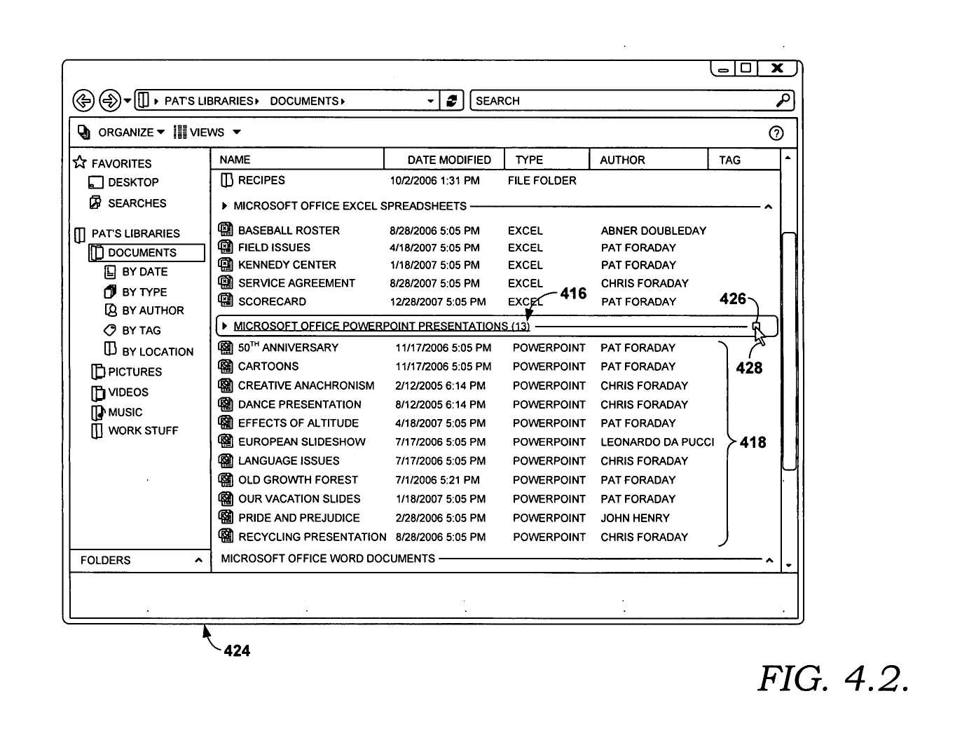

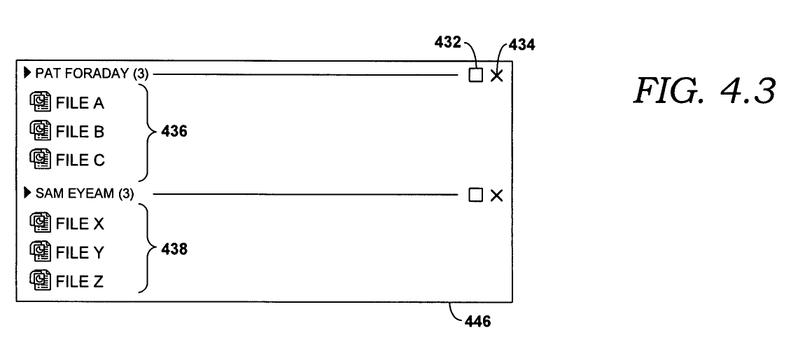

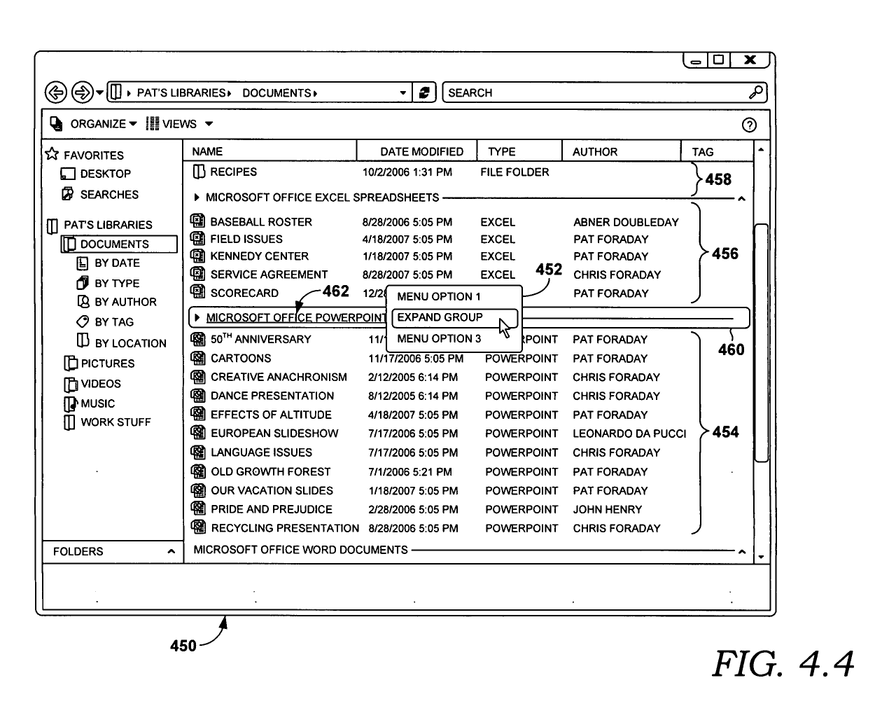

In one embodiment, interacting with different aspects of a delimiter can cause different functional outcomes. For example, in one embodiment different manipulation options are made accessible by way of the group delimiter. A first illustrative manipulation option enables removing a desired group from the view. A second manipulation option enables showing only a selected group in a view. These manipulation options can be accessed by interacting with the delimiter. For example, consider FIG. 4.1.

In FIG. 4.1, the groups of FIG. 3 are shown as well as a pointer 412 and are depicted in view 410. Pointer 412 provides feedback to a user who is controlling a pointing device, commonly referred to as a mouse. One aspect of the invention that is being shown in view 410 is that when a pointer hovers over a group header 414, it can be used to provide feedback to a user that the delimiter can be interacted with in a certain way. In a first illustrative way, a portion of the delimiter 416, namely the group header 414, can be acted on to cause a certain outcome.

A first illustrative outcome may to be filter out all other representations except those representations that are depicted in the group that is denoted by its corresponding delimiter. By way of example, clicking on “Microsoft Office PowerPoint Presentations (13)” may cause only representations 418 to be presented. The other representations in view 410 would be filtered out of view, or closed. Thus, we have described one embodiment of the manipulation option, or UI mechanism, that enables showing only a selected group in a view. Namely, we have indicated that one way to show only a desired set of representations is to click on a group heading.

There are other ways to directly interact with UI elements to effect a desired view. Another illustrative UI mechanism that would enable a user to directly interact with items of a view is depicted in FIG. 4.2.

The view in FIG. 4.2 is referenced by numeral 424. View 424 shows another embodiment of a manipulation option that is referenced by numeral 426. Manipulation option 426 could also enable showing only group 418. An illustrative use case is that a user may hover a pointing device 428 over delimiter 416 to cause manipulation option 426 to be presented, thereby enabling a user to select manipulation option 426 to effect a desired change. Thus, in some embodiments, the manipulation options are hidden from view until a user interacts with an aspect of the view, such as the delimiter. And in other embodiments, the manipulation options are persistently viewable so that a user may see them all the time. These options can be user configurable or built into embodiments of the present invention so that they are predetermined. Thus, in one embodiment, manipulation options are not viewable until a user action is received, but in other embodiments the manipulation options are always viewable to a user.

Instead of performing a filter function, manipulation option 426 could also invoke a close option. In such an embodiment, selecting a close option would remove a desired group from the view. Thus, in one embodiment of the invention, manipulation option 426 serves as providing a UI mechanism that, when selected, closes group 418. As will be discussed in greater detail, closing a group according to embodiments of our invention is different than collapsing a group. FIG. 4.3 shows an example of presenting two separate manipulation options, the first being referenced by numeral 432 and the second being referenced by numeral 434. Clicking option 432 would produce the result of showing only the elements in group 436, while selecting option 434 would cause group 436 to be closed, rendering viewable only the items in group 438.

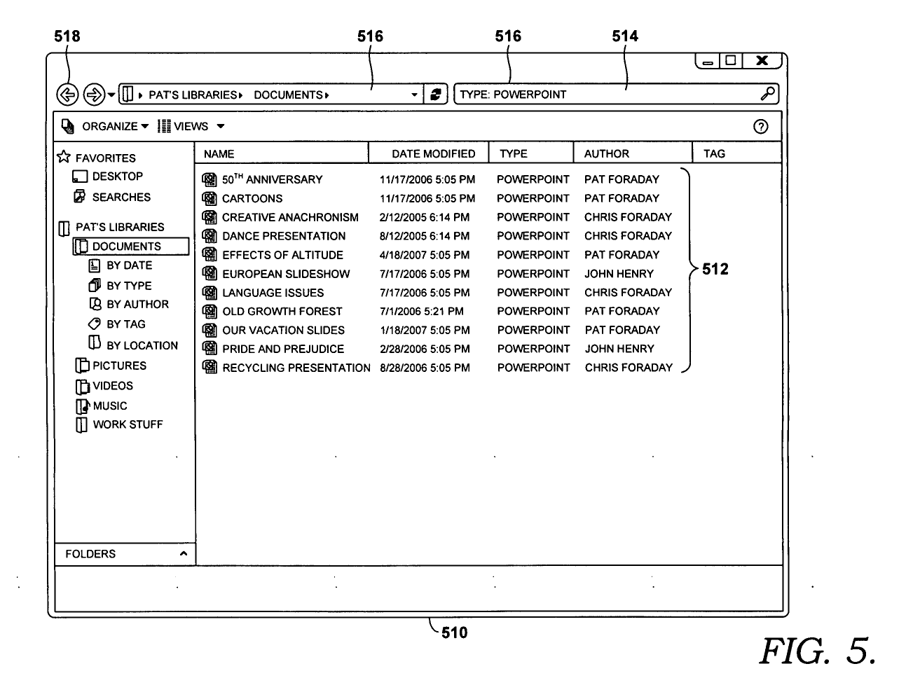

Turning now to FIG. 4.4, a view 450 depicts yet another illustrative embodiment of a manipulation option that is made available to interact with elements of a view. A context menu 452 is shown that includes a set of menu options. Illustrative menu options, though not shown, could include filtering, closing, or others. A filter, or show-only, option would operate to show only elements 454 to the exclusion of elements 456 and 458. A variety of ways are available for presenting context menu 452. For example, in one embodiment a user may right click or double click delimiter 460. In another embodiment, a user may click on label 462, which we have already mentioned may operate to effect or cause elements 454 to be the only elements presented. The action of showing only items of a desired group may be known in the art as “zooming.” An example of zooming into a group is shown in FIG. 5 by view 510.

View 510 is a depiction of the results of receiving an indication from a user that only a certain group is desired to be presented. Accordingly, view 510 is an example of zooming into a set of representations, variously referred to as showing only a set of representations, which is referenced by numeral 512. View 510 also shows that a filter-reflection mechanism 514 is employed to provide visual feedback to a user that describes the instant filter. In the illustrative example of view 510, label 516 indicates a type of “PowerPoint,” which is a type of presentation file. The actual type of file is not relevant, only that the instant filter being shown in the view is reflected in some way. In one embodiment, a textual representation is shown in a text box, namely box 514.

Another box, which is referenced by numeral 516, indicates that a stack can be maintained that will allow users to revert to previous views. In one embodiment, this is accomplished by acting on a “back” button 518. If a user were to act on button 518 from view 510, they would revert to view 450 in one embodiment. Thus, even though users may successively apply various filters, prior stages or states can be reached by acting on the back button 518 or the like. The specific button 518 or other mechanism is not as important as the back embodiments of the invention that enable a user to reach a prior state.

Previously, we had mentioned that one aspect of the invention is that it allows a filtered set to be further grouped into additional groups; namely, without including items from all of the other groups. Thus, these embodiments differ from merely collapsing a group. When a group is collapsed, a group header remains and if a subsequent filter is attempted to be applied to the remaining-visible items, then even the items of the collapsed set are reflected in the subsequently filtered set.

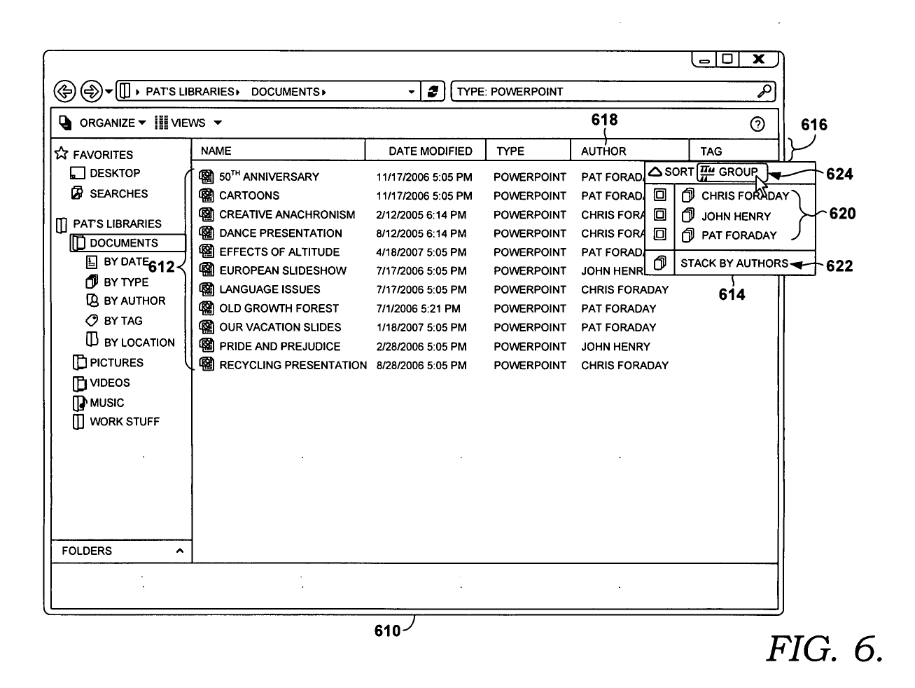

Consider view 610 of FIG. 6. This view is the same as that of 510, but, as if often the case throughout this disclosure, receives its own numeral to make referring different items in the drawings easier. Assume that it is desirable to apply a subsequent filter to representations 610, which are the only elements shown as a result of applying a first filter. A filter menu 614 illustrates that column headers 616 can be interacted with to cause another grouping.

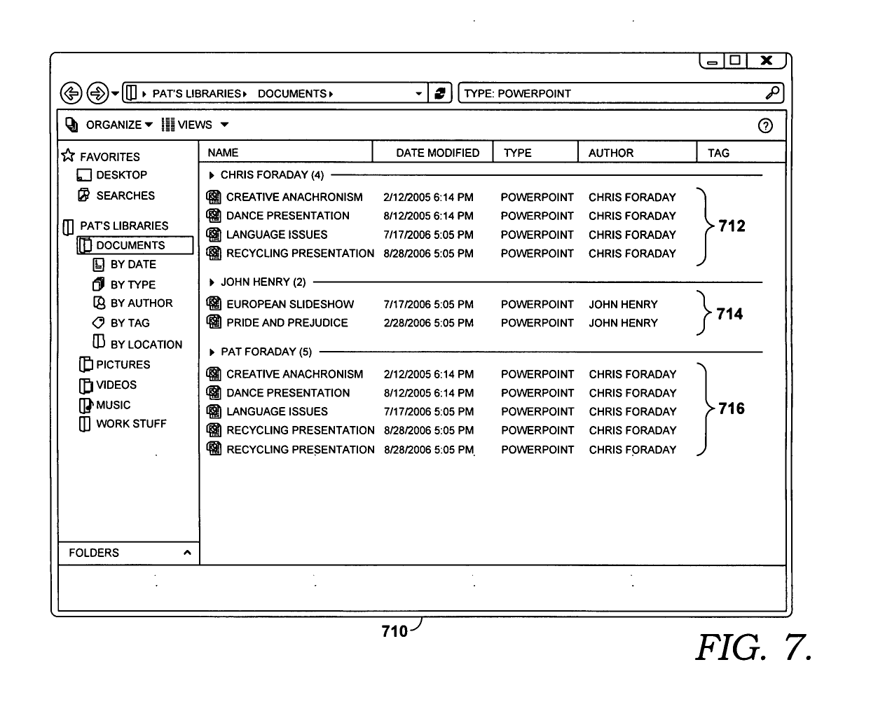

As illustratively shown, the “author” heading 618 has been interacted with to cause filter menu 614 to be presented, which presents three options 620 to group representation 612. In one embodiment, an option 622 provides for an ability to stack element 612 by authors. In one embodiment a button 624 enables element 612 to be grouped. In some embodiments, the options of 620 can be employed to cause a selection of a set of elements to be filtered out. For example, it might be the case that one of the boxes next to an author's name causes representations associated with that author to be filtered out. If a user indicates that elements 612 are to be further grouped by author, then a view similar in functionality to that of view 710 in FIG. 7 will be presented.

As can be seen from view 710, three groupings now exist, which are referenced by numerals 712, 714, and 716. Each of the respective views are grouped by a property of the items to which the representations correspond; namely, by author in this example. As mentioned, elements that are missing from view 710 include elements that were not in the set 612 of items to which a subsequent filter was applied. That is, the elements in view 710 are only those elements that existed in the previous view 610. By way of illustration, the elements that are shown in FIG. 4 and other figures are not part of the set of elements that are shown in view 710.

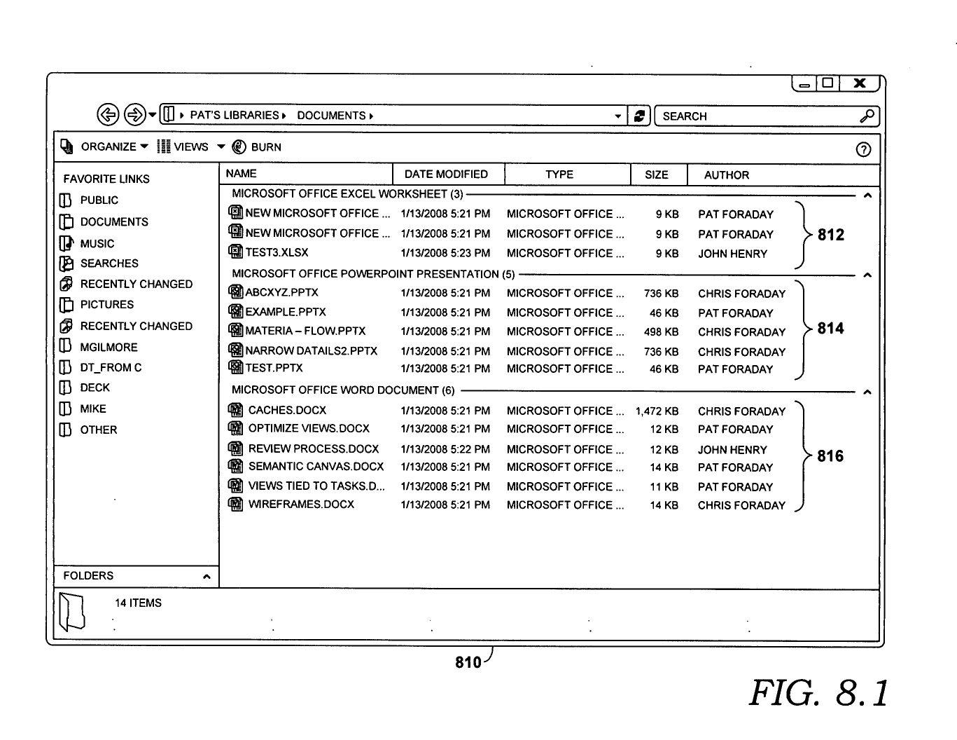

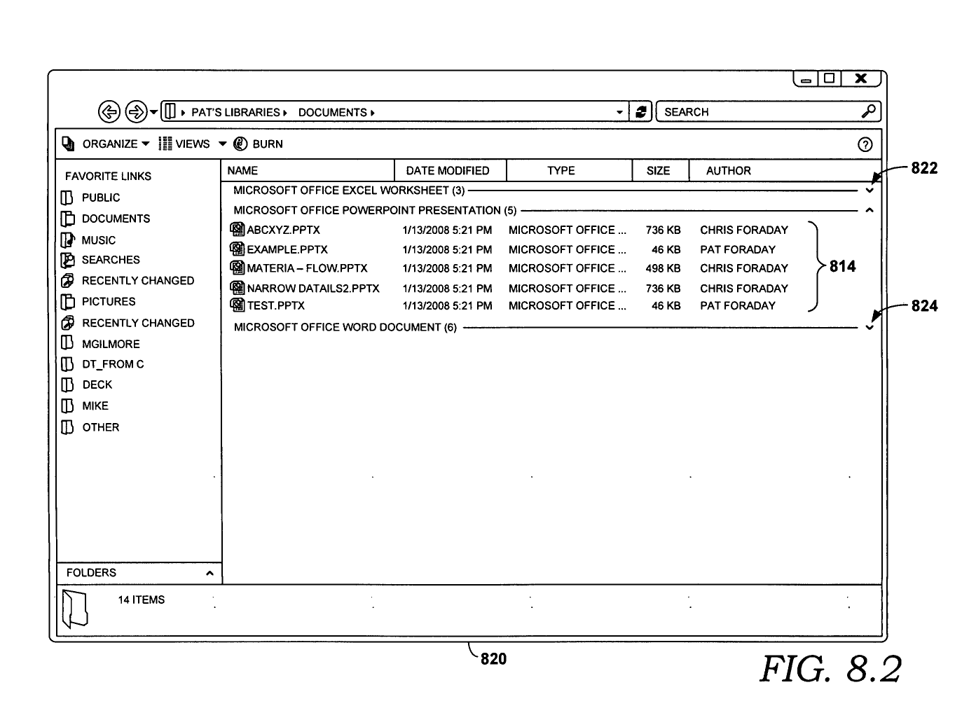

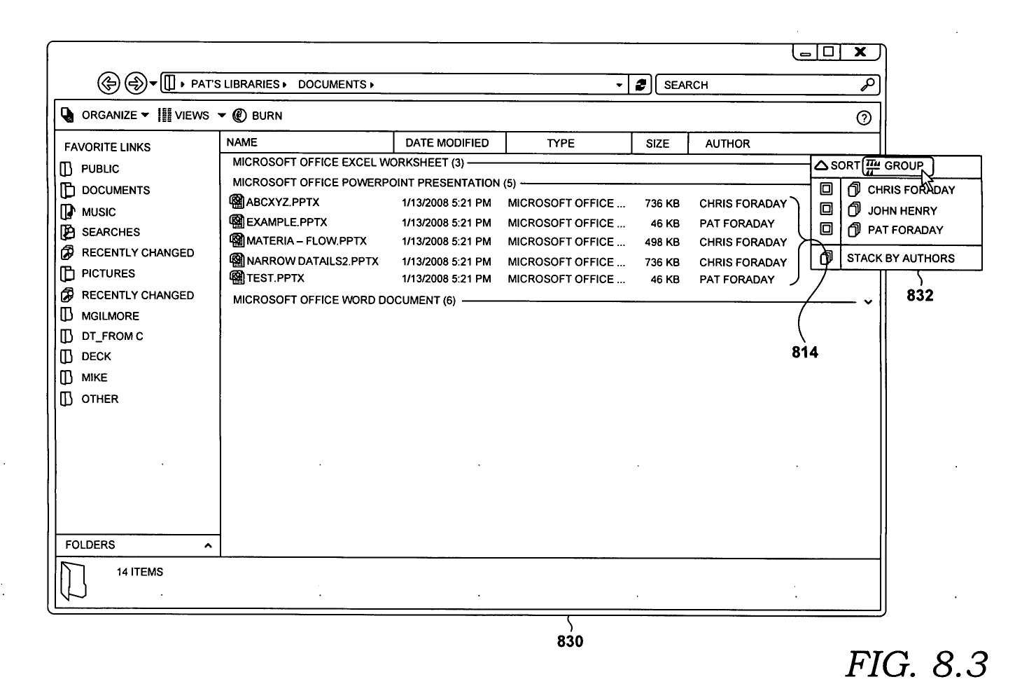

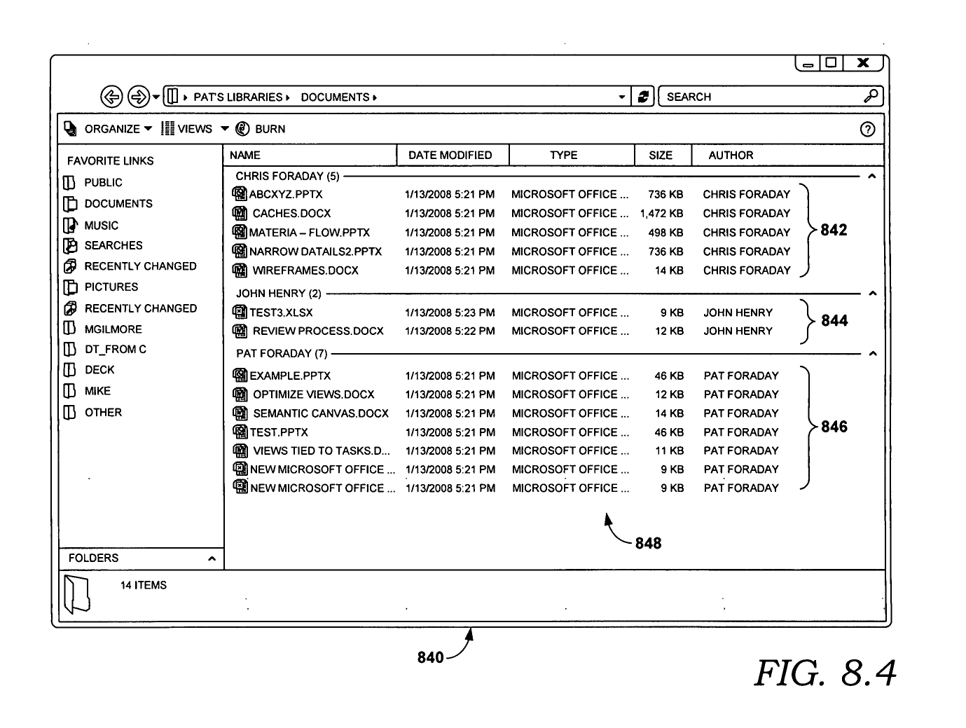

This point is even shown more clearly in FIGS. 8.1-8.4. Turning to FIG. 8.1, a view 810 is shown to include three current groupings; namely grouping 812, 814, and 816. In FIG. 8.2, view 820 shows that groups 812 and 816 have been collapsed. This is indicated by arrow icons 822 and 824. Thus, in view 820, two groups have been collapsed while a third group 814 remains visible. Note, that groups 812 and 816 have merely been collapsed. In FIG. 8.3, a context menu 832 is used to attempt to apply a subsequent group to elements 814. But as view 840 in FIG. 8.4 reflects, all of the other elements from FIG. 8.1 are present in view 840. That is, elements 812 and 816 are reflected in the subsequent groupings 842, 844, and 846 that are shown in FIG. 8.4. The result shown in FIG. 8.4 would not occur in our invention to the extent that the additionally filtered result 848 includes elements that were not part of the original set 814.

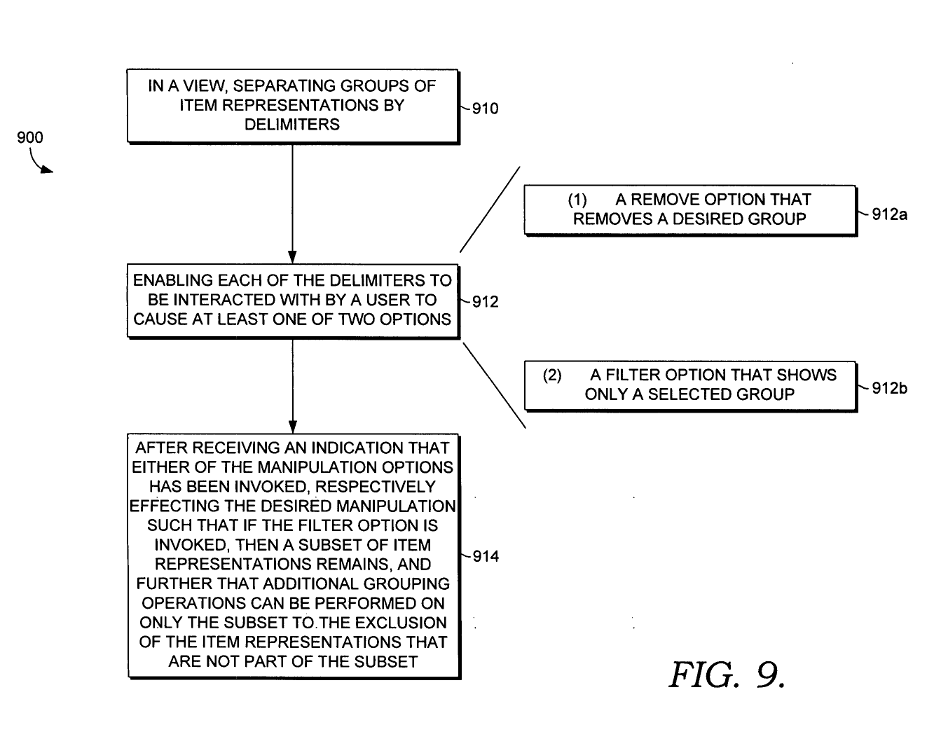

Turning now to FIG. 9, an illustrative method for managing a presentation of a set of representations of items in a view is depicted in a flow chart and referenced generally by the numeral 900. As previously mentioned, the representations that we are referring to are representations of items in a computing environment; and as also mentioned, illustrative items include files as well as network elements, users, and the like. At a step 910, groups of item representations are separated by delimiters. With illustrative reference to FIG. 3, an example of separating groups of item representations is shown wherein three groups 312, 314, 316 are separated by delimiters 320 and 322. We reference FIG. 3 only by way of example to help illustrate an example in connection with discussing the flow diagram. But FIG. 3 should not be construed as the only embodiment of the invention.

At a step 912, each of the delimiters is enabled to be interacted with by a user to cause at least one of two options. As is normally the case, we do not mean to imply a temporal order in which the events that we are explaining occur. That is, enabling the delimiters to be interacted with does not necessarily need to occur in a separate step after the groups are separated in step 912. The two can happen substantially contemporaneously such that when the groups are separated, the delimiters are already enabled to be interacted with by a user.

We have previously described above different ways that the delimiters can be interacted with to cause at least one of two options (such as a remove option that removes a desired group or a filter option that shows only a selected group, which steps are respectively referenced by numerals 912A and 912B). As previously mentioned, illustrative ways of interacting with a delimiter, such as delimiter 320, is to enable a group heading label (such as 414 in FIG. 4.1) to be interacted with, enabling hidden UI selectable options (such as 428, 432, or 434) to be presented incident to receiving a user action (such as hovering, double clicking, right clicking, etc.), persistently presenting UI selectable options so that no user interaction is necessary to view them, or enabling a context menu of options to be presented after receiving a user action that is directed toward the delimiter. The list of four illustrative options is not exhaustive but is exemplary of ways to correctly interact with the representations in a view by way of UI mechanisms.

With reference to numeral 912A, we have explained that invoking the remove option causes a deletion of representations of other items that have in common a property that was shared by the items that form the removed group even if those other items were not in the removed group. This aspect is best explained in connection with explaining the concept of multivalue properties. A multivalue property is a property that can include multiple values. An illustrative example of a multivalue property is an author property. A document may have multiple authors.

For example, a document may be authored by Jane as well as John. In this example, an author attribute or property of a file includes two values; namely “John” and “Jane.” In one embodiment of the instant invention, if all of the representations of a view were filtered by author, and a user opts to close the group of representations that is associated with the author “John,” then any instance of a file representation that might occur in another group that has John as an author will also be removed. So if the group of representations for Jane includes an element where John is an author, then when the John group is closed, the element that has John as an author in Jane's group will also be removed. But in other embodiments only those items directly associated with a specific group are closed. Both embodiments are contemplated as part of our invention.

Step 914 summarizes some aspects that we've already described, in that after receiving an indication that either of the aforementioned manipulation options has been invoked, an embodiment of the invention will cause the respective desired manipulation to occur such that if the filter option is invoked then a subset of the original representations will be all that remains, and further that additional grouping operations can be performed on only the subset to the exclusion of the item representations that are not part of the aforementioned subset. We explained an example of this in connection with FIGS. 6 and 7. FIG. 6 shows a filtered set 612. This set 612 is a subset of the original set of elements that are shown in FIG. 4.4. FIG. 7 shows that subset 612 has an additional grouping operation applied to it to create groups 712, 714, and 716 but which further groupings do not include any representations that were not part of the original subset 612.

As mentioned, the remove option (such as shown in FIG. 4.3 and referenced by numeral 434) removes a desired group from the view including removing any corresponding group header that was associated with the group that was removed from the view.

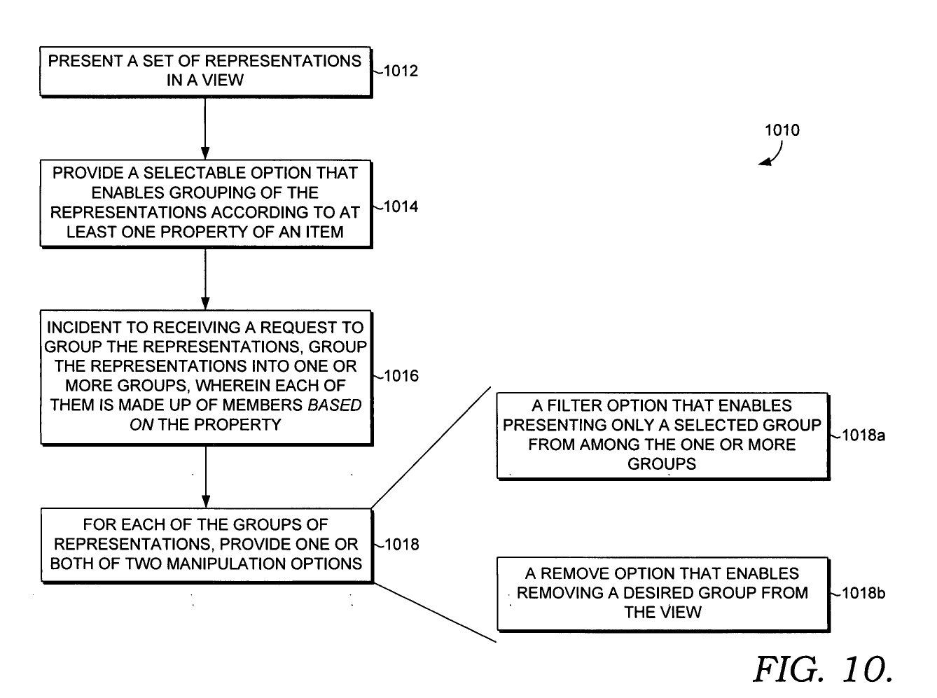

Turning now to FIG. 10, another illustrative method of managing a presentation of a set of representations of items in a view is provided and referenced generally by the numeral 1010. At a step 1012, a set of representations is presented in a view. An illustrative example of this is provided in FIG. 4.4. At a step 1014, one or more selectable options is provided that enables grouping of the representations according to at least one property of an item. We have previously discussed the various forms that the selectable option(s) may assume. We have also discussed grouping the representations based on at least one property of an item represented by a corresponding representation. An illustrative selectable option that enables such grouping may take the form of a column heading, such as those shown in FIG. 3, wherein a specific example includes a file type, which is referenced by numeral 318.

At a step 1016, the representations are grouped into one or more groups, wherein each of the groups is made up of numbers based on at least one property of the items being represented. For example, representations may be grouped by name, date modified, type, size, author, etc. And as we have mentioned before, to be grouped based on a property does not necessarily imply that that property is identically shared across members of the group. For example, grouping items by size does not necessarily require that the items be the exact same size, but that they share some aspect of size with each other. For example, a first set of members may be less than a certain file size and the next set less than a next threshold, and the next less than still another threshold, etc.

At a step 1018, one or both of two manipulation options is made available and associated with each of the groups of representations. Two illustrative manipulation items include a filter option 1018A that enables presenting only a selected group from among the one or more groups and a remove option 1018B that enables removing a desired group from the view. Each of these options has been previously discussed and will not be discussed again here for the sake of conciseness.

Many different arrangements of the various components depicted, as well as components not shown, are possible without departing from the spirit and scope of the invention. Embodiments of the invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. One or more computer-readable media have computer-executable instructions embodied thereon for presenting on a computing device a view, wherein the view is a bounded user interface (UI) portion that contains representations of items, the view comprising:
a plurality of groups of one or more representations corresponding to one or more items, wherein the one or more representations are grouped together based on at least one property of at least one of the one or more items;
a group delimiter that separates each of the plurality of groups; and
at least one of two manipulation options that are accessible by way of the group delimiter,
(1) wherein a first manipulation option enables removing a desired group from the view, and
(2) wherein a second manipulation option enables showing only a selected group in the view.

2. The media of claim 1, wherein the items are files, and thus the representations of items are representations of the files.

3. The media of claim 1, wherein the at least one property includes one or more of the following:
a file author;
a file size;
a file name;
a file type;
a date;
a file location;
an item of metadata associated with an audio file;
an item of metadata associated with a video file; and
an item of metadata associated with a picture file.

4. The media of claim 1, wherein the group delimiter includes group heading that label each of the plurality of groups.

5. The media of claim 4, wherein the manipulation options are not viewable until a user action is received, and wherein the user action includes hovering a mouse pointer over an area that triggers a presentation of one or both of the manipulation options.

6. The media of claim 1, wherein the first manipulation option includes a first selectable UI-mechanism that, when selected, removes from visibility the desired group as well as any group header that might be associated with the desired group.

7. The media of claim 1, wherein the second manipulation option includes a second selectable UI-mechanism that, when selected, removes from visibility all other groups except for the selected group, thereby leaving visible a first filtered set.

8. The media of claim 7, wherein the items making up the first filtered set can be further grouped into additional groups without including items from the all other groups.

9. A method for managing a presentation of a set of representations of items in a view, wherein the view is a bounded portion of a user interface (UI) that contains the set of representations, the method comprising:
separating a plurality of groups of item representations by delimiters;
enabling each of the delimiters to be interacted with by a user by way of at least one of two manipulation options,
(1) wherein the first manipulation option is a remove option that removes a desired group, and
(2) wherein a second manipulation option is a filter option that shows only a selected group; and
incident to receiving an indication that either of the manipulation options has been invoked, respectively effecting the desired manipulation such that if the filter option is invoked, then a subset of item representations remains, and further that additional grouping operations can be performed on only the subset to the exclusion of the item representations that are not part of the subset.

10. The method of claim 9, wherein the item representations represent one or more of the following:
files;
network elements; and
users.

11. The method of claim 10, enabling each of the delimiters to be interacted with includes one or more of the following:
enabling a context menu of options to be presented incident to receiving a user action directed toward the delimiter, wherein the user action includes one or more of,
(1) pointer hovering,
(2) clicking;
(3) double clicking, and
(4) right clicking;
enabling a group-heading label of the delimiter to be interacted with;
enabling hidden UI selectable options to be presented incident to receiving user action; and
persistently presenting UI selectable options.

12. The method of claim 10, wherein invoking the remove option causes a deletion of representations of other items that have in common the property that was shared by the items that formed the removed group even if those other items were not in the removed group.

13. The method of claim 10, wherein invoking the filter option results in a filtered set of remaining representations being presented to the exclusion of all other representations not in the filtered set.

14. The method of claim 13, further comprising grouping the remaining representations into further groups incident to receiving a request to further group the remaining representations, wherein grouping the remaining representations happens to the exclusion of the all other representations such that the further groups are composed only of representations of the filtered set.

15. The method of claim 14, further comprising:
enabling an undo action for each user action received such that a user can successively revert back to a prior presentation of representations.

16. One or more computer-readable media having computer-executable instructions embodied thereon for performing a method of managing a presentation of a set of representations of items in a view, wherein the view is a bounded portion of a user interface (UI) that contains the set of representations, the method comprising:
presenting the set of representations in the view;
providing a selectable option that enables grouping of the representations according to at least one property of at least one item;
incident to receiving a request to group the representations, grouping the representations into one or more groups, wherein each of the one or more groups is made up of members based on the at least one property;
for each of the groups of representations, providing one or both of two manipulation options,
(1) wherein the first manipulation option includes a filter option that enables presenting only a selected group from among the one or more groups, and
(2) wherein the second manipulation option includes a remove option that enables removing a desired group from the view.

17. The media of claim 16, wherein the filter option is operative to present the selected group to the exclusion of all other groups.

18. The media of claim 17, wherein, incident to invoking the filter option, the selected group is further grouped into additional groups that do not contain items from the all other groups.

19. The media of claim 16, wherein only a maximum of N members of each of the one or more groups is presented in the view.

20. The media of claim 16, wherein for the one or more groups to be made up of the members based on the at least one property comprises:
each of the members share a common aspect of the at least one property while not necessarily having in common identical values of the property.
